(19) United States
(12) Patent Application Publication
(10) Pub. No.: US 2014/0300211 A1
(43) Pub. Date: Oct. 9, 2014

(54) Discrete Motion System

(71) Applicants: Nadya M. Peek, Cambridge, MA (US); William Kai Langford, Greenwich, CT (US); Neil A. Gershenfeld, Cambridge, MA (US); Matthew Eli Carney, Cambridge, MA (US)

(72) Inventors: Nadya M. Peek, Cambridge, MA (US); William Kai Langford, Greenwich, CT (US); Neil A. Gershenfeld, Cambridge, MA (US); Matthew Eli Carney, Cambridge, MA (US)

(73) Assignee: MASSACHUSETTS INSTITUTE OF TECHNOLOGY, Cambridge, MA (US)

(21) Appl. No.: 14/199,698

(22) Filed: Mar. 6, 2014

Related U.S. Application Data
(60) Provisional application No. 61/773,717, filed on Mar. 6, 2013.

(51) Int. Cl. H02K 41/03

(52) U.S. Cl. CPC H02K 41/03
USPC 310/12.17; 29/596

(57) ABSTRACT

Discrete motion systems move relative to a lattice, using bistable mechanisms to snap between lattice locations. A discrete motion system includes a lattice having a regular configuration of attachment points, one or more motion modules that move across the lattice in discrete increments, and controllers that direct the modules. A module includes a body, actuators, and feet having mechanisms for attaching and detaching the module from the lattice. The module may include actuated joints that cause movement of arm structures to engage and disengage the feet from the lattice. The module may be a digital inchworm, and may be a relative assembler having at least one assembler arm. A method for discrete extensible construction includes creating a lattice having a regular configuration of attachment points, causing a discrete motion relative assembler to systematically move across the lattice in discrete increments, and causing placement of materials by the assembler arm.

### RELATED APPLICATIONS

This application claims the benefit of U.S. Provisional Application Ser. No. 61/773,717, filed Mar. 6, 2013, the entire disclosure of which is herein incorporated by reference.

### STATEMENT REGARDING FEDERALLY SPONSORED RESEARCH OR DEVELOPMENT

This invention was made with U.S. government support under Grant Number W911NF-11-1-0096, awarded by the Department of Defense. The government has certain rights in this invention.

### FIELD OF THE TECHNOLOGY

The present invention relates to extensible machine design and, in particular, to an extensible discrete motion system.

### BACKGROUND

To design high-quality motion systems, engineers need to balance stiffness, with its resulting accuracy and precision, against cost and weight. They need to balance resolution with total volume, and speed with control. Rails, bearings, lead screws, belts, and pulleys all allow the engineer to transform force from a motor into linear motion. The size of each component forms a critical part of the overall machine budget, where backlash, thermal issues, and build volume all must be taken into account while addressing the machine's goals of precision, accuracy, and resolution.

Each time a motion system is specified that is different in range from the previous motion systems fabricated, new power transmission parts must be acquired. Engineers are dependent on lead times, which may be months, for the particular power transmission components to be available. All parts are required for the motion of the machine, yet it is uncommon to keep an inventory of all the guide shafts, lead screws, and bearings that might be needed for any particular motion control application. Waiting for parts therefore adds a high cost to custom CNC applications, making rapid turnaround difficult and expensive for custom automation problems.

Methods that circumvent the use of certain power transmission component have been previously proposed. Linear (also known as Sawyer) motors do not require guide shafts or lead screws, but instead incorporate the electromagnetic system that drives the motion into the structure itself [U.S. Pat. No. 3,457,482; Sawyer; “Magnetic Positioning Device”; 1969]. However, such motors require precise fabrication of the motion plate or platen, which needs to cover the full range of motion of the machine. This is arguably an even more complicated power transmission problem.

Independently moving inchworm robots that allow for generalized positioning [K. Kotay and D. Rus, “Navigating 3d steel web structures with an inchworm robot”, Intelligent Robots and Systems '96, IROS96, Proceedings of the 1996 IEEE/RSJ International Conference, vol. 1, pages 368-375; November 1996] have been previously proposed, but they lack the accuracy and repeatability required for machining applications with loads and cannot move in two separate axes simultaneously. Without a grid structure to adhere to, they easily lose position, making them unsuitable for high resolution fabrication tasks.

### SUMMARY

Discrete motion systems according to the invention move relative to a lattice and use bistable mechanisms to toggle or snap between stable lattice locations. The discrete motion systems of the invention can be physically implemented in many ways that will be apparent to one of skill in the art, including inch-worm and stapler-type models, and in particular can be used as the basis of discrete motion relative assemblers and discrete extensible construction systems and methodologies.

In one aspect of the invention, the discrete motion system includes a lattice having a regular configuration of attachment points, one or more discrete motion modules that move across the lattice in discrete increments, and one or more controllers that direct actuation and movement of the motion modules. The motion modules each include a module body, one or more actuators, and one or more feet that are responsive to actuation of the actuators and have at least one attachment mechanism that alternately attaches and detaches the motion module to the lattice at one or more of the regular attachment points. The feet may be attached to the module body by at least one arm or leg structure. The discrete motion module may include one or more actuated joints that cause movement of the arm structure to cause engagement and disengagement of the foot from the lattice. The attachment mechanism may be an end-effector that fits into the regular attachment points on the lattice. The controller or controllers may control the system remotely system, such as via a wireless link or conductive pieces in the lattice, or a controller may be on-board each motion module. The system may be powered by onboard or remote power sources.

The discrete motion module may be a digital inchworm, and may comprise one or more piston arm actuated joints attached to the module body by a pivot hinge, the piston arm being configured to extend and contract under control of the actuator, and the foot being a ratcheting chamfer that rides up the lattice while the piston arm is extending, and slides over and locks downward to pull the motion module forward along the lattice while the piston arm is contracting. The discrete motion module in the discrete motion system may be a discrete motion relative assembler that has at least one assembler arm. A discrete motion relative assembler may be used to make additions to the lattice using the assembler arm.

In another aspect of the invention, a discrete motion relative assembler includes a discrete motion module that moves across a lattice in discrete increments defined by a regular configuration of attachment points on the lattice and one or more controllers that direct actuation and movement of the motion module. The discrete motion module of a discrete motion relative assembler includes at least one actuator configured to cause movement of the motion module across the lattice, a module body connected to the actuator or actuators, one or more foot having at least one attachment mechanism that is controllable to alternately attach and release the motion module to and from the lattice at one or more of the regular attachment points, and at least one assembler arm for placing materials. The feet may be attached to the module body by at least one arm or leg structure. The module may include one or more actuated joint that causes movement of the arm structure to cause engagement and disengagement of the foot from the lattice. The discrete motion relative assembler may be a digital inchworm.

In another aspect of the invention, a method for discrete extensible construction includes the steps of creating a lattice having a regular configuration of attachment points, causing a discrete motion relative assembler to systematically move across the lattice in discrete increments defined by the regular configuration of attachment points on the lattice, and causing placement of materials by the assembler arm. The materials placed by the assembler arm may be lattice pieces and the assembler arm may use them to make additions to the lattice.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 depicts an exemplary embodiment of a linkage mechanism that enables discrete motion via kinematic constrained locating feet, according to one aspect of the invention;

FIGS. 2A-D depict an exemplary mechanically-cammed latching joint that a discrete motion module might use to lock into a lattice;

FIGS. 3A-B depict an exemplary discrete motion system that employs mechanical latches;

FIG. 4 depicts an exemplary discrete motion system that employs an inchworm-type discrete movement sequence of actuations;

FIG. 5 is an illustration of an exemplary embodiment of a digital inchworm with a ratchet-type mechanism;

FIG. 6 depicts an exemplary embodiment of a cam mechanism for producing a square end-effector trajectory from rotary motion;

FIG. 7 depicts an exemplary embodiment of a cube-oct lattice assembler robot;

FIG. 8 depicts an exemplary embodiment of a discrete assembler according to one aspect of the invention, comprising digital inchworms according to FIG. 5 depositing digital material parts as they crawl across a lattice;

FIG. 9 depicts an exemplary discrete motion system for a digital assembler resembling a stapler;

FIG. 10 depicts an exemplary discrete motion system with a digital motion stage under a spindle;

FIG. 11 depicts an exemplary discrete motion system wherein the head moves along 4 arms that can move parallel to the grid structure;

FIG. 12 depicts an exemplary discrete motion system wherein the head moves along 3 arms that can move parallel to the grid structure;

FIG. 13 depicts an exemplary setup having a 3d print head mounted on an xy inchworm;

FIGS. 14A-B depict exemplary lattice geometries usable with the present invention;

FIG. 15 depicts an exemplary lattice tile system that permits the head of the digital inchworm to attach to the tile with a kinematic coupling;

FIG. 16 is a ‘belly up’ depiction of an exemplary digital inchworm that would attach to a lattice tile system such as the one depicted in FIG. 9;

FIG. 17 is an exemplary discrete motion system in which the lattice tile structure that the digital inchworm head climbs on is covered in unique optical encoding;

FIG. 18 depicts an exemplary discrete motion system having a flexural closed loop motion stage layered on top of the digital inchworm stage on a discrete grid;

FIG. 19 depicts the exemplary embodiment of FIG. 10, adapted to provide wireless remote control of the assembler;

FIG. 20 depicts the discrete assembler of FIG. 5, controlled and powered through the lattice;

FIG. 21 is a flowchart of an exemplary general control algorithm for a discrete relative motion system according to the invention; and

FIG. 22 is a flowchart of an exemplary control algorithm for the stapler-style discrete relative motion system of FIG. 9.

### DETAILED DESCRIPTION

A discrete (digital) motion system according to the invention is configured to move relative to a lattice and use bistable mechanisms to toggle or snap between stable lattice locations. Extensible machine design is achieved by a motion system that can be extended by adding discrete parts to an array of passive structures. Using a tiling grid that an active relative assembler, such as a digital inchworm head or stage, moves around on, the size of a computer-controlled fabrication machine can then be extended on demand. Each lattice tile added extends the space that the head of the machine can move in.

In one aspect, an extensible discrete motion system according to the invention uses an active moving head (such as, but not limited to, a digital inchworm) that moves along a passive extensible grid structure. The active moving head uses a continuous positioning system to move along the discrete grid structure, while either applying traditional additive or subtractive fabrication techniques, or building up digital materials. The digital materials built up can also then form a continuation of the passive grid the head uses for locomotion. The positioning of the head with respect to the grid may be either closed or open loop, incorporating encoders in the grid structure in case of the former. It will be apparent to one of skill in the art that many different geometries for lattice tile structures and many different types of heads are suitable for use in the present invention.

In one aspect, the invention comprises methods of moving relative to discretely assembled lattices or grids. These modules can be coupled together to form discrete motion systems. These systems move discretely, such that they “snap” into stable lattice locations. If given the ability to place parts, a digital motion system can extend the lattice on which it moves. Furthermore, these systems can be used to re-create traditional gantries and hold analog tool-heads such as, but not limited to, milling spindles and FDM extruders.

Discrete motion. If it is not possible to completely circumvent the need for power transmission parts in an application where power needs to be transmitted, their use can at least be generalized. Instead of using global positioning parts, local positioning on a global grid is used. The grid (or lattice) forms a passive structure that enables precise positioning, and it can be extended to fit the application by adding more grid tiles. The precise positioning is made possible with discrete motions which can be enabled purely mechanically or with electromagnetic elements such as those used in linear motors.

Discrete motions are bistable motions; that is, they are motions that determinately snap between stable points while their intermediate transition positions may be indeterminate along their path between stability points. Discretized motions can be programmed mechanically, trading the cost and complexity of precision components and control for naturally stable positioning features. Example mechanisms that may embody discrete motions include, but are not limited to: cams, ratchets, latches, solenoids, gearing, ball and sockets, over-under mechanisms, and any similar types of mechanisms with multiple natural stability points.

FIG. 1 depicts an exemplary embodiment of a linkage mechanism that enables discrete motion via kinematically-constrained locating feet. In FIG. 1, two degree-of-freedom 4-bar linkage 105 traverses lattice 110 (shown in side view) via kinematically locating feet 120. The motion trajectory of linkage 105 is shown by ghosted linkage images 130, 135 and ghosted feet images 140, 145. Kinematically locating feet 120 allow the motion module to “snap” into place and locate itself very precisely with respect to lattice 110.

An exemplary embodiment comprises a bistable or latching solenoid. In this instance, the solenoid is a linear motion system that is stabilized in any of only two states by latches. An activation energy, in this case a magnetic field, is applied to generate a force to overcome the latch and kick the linear actuator into the next region of stability of position two. The change of state from position one to position two requires a single state change, of energizing the magnetic field a one-bit activation, resulting in a single deterministic motion—a one-bit motion. This change of state happens with an input of energy and movement of mass with force, a discretized unit of work and as defined an embodiment of a one-bit actuator.

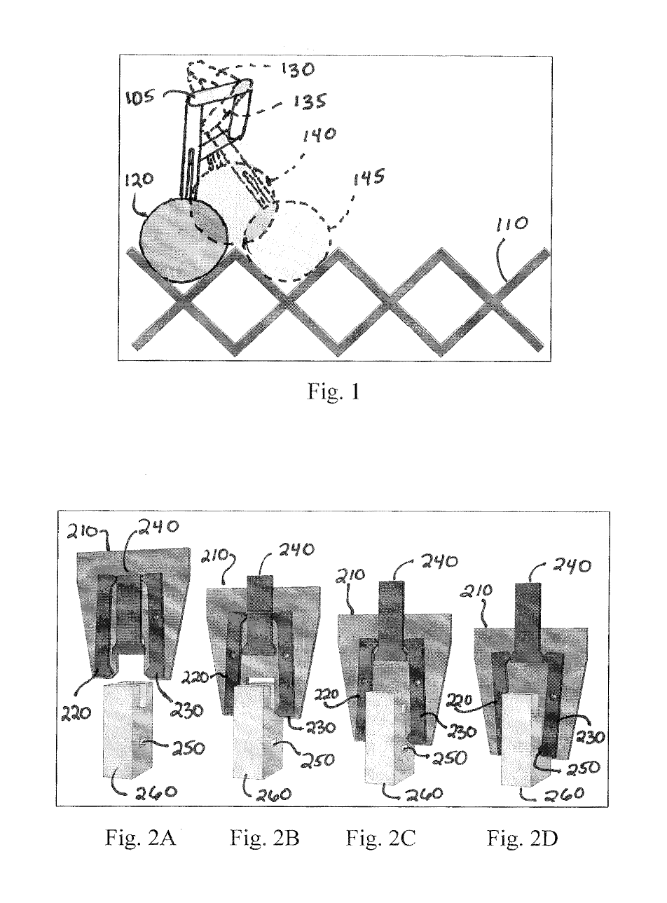

FIGS. 2A-D depict an exemplary embodiment of a mechanically-cammed latching joint that a discrete motion module might use to lock into a lattice. The sequence of images, FIG. 2A to FIG. 2D, show that, as assembler foot 210 is lowered (FIG. 2A), cammed locking arms 220, 230 ride on central cam 240 and fit into slot 250 in lattice part 260. As foot 210 is raised from part 260 (FIGS. 2B-D), locking arms 220, 230 disengage from cam 240 and foot 210 is free to move to another lattice piece.

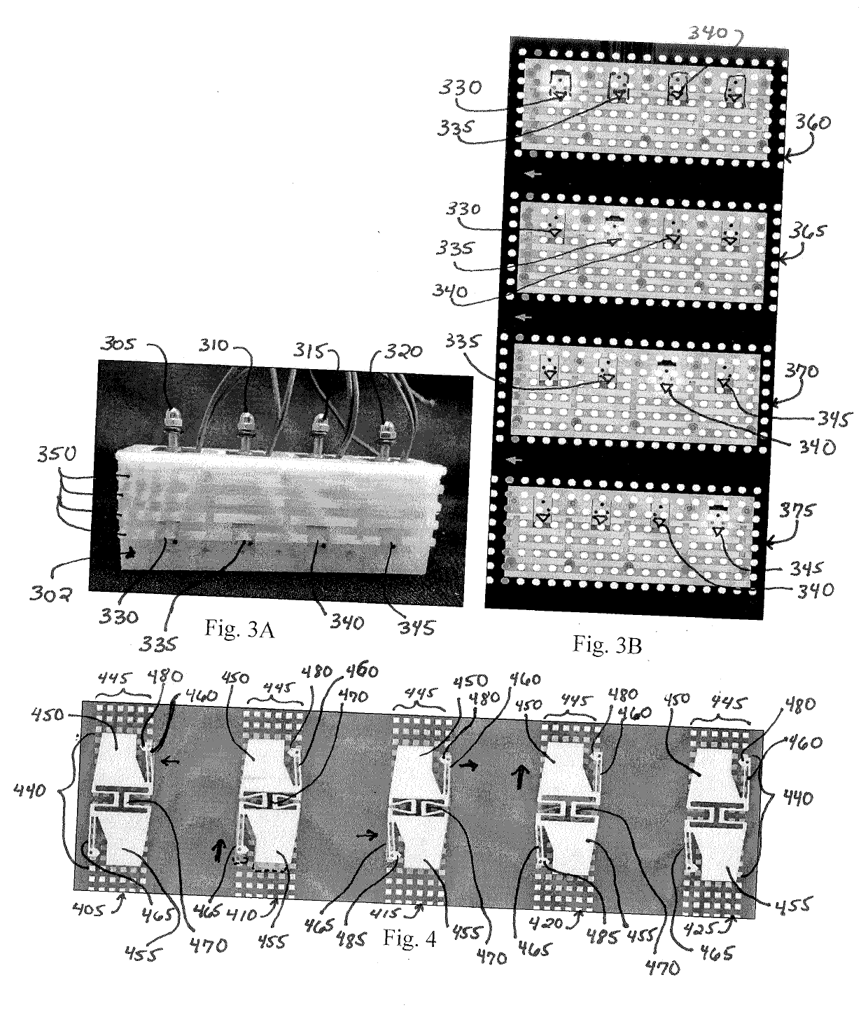

This one-bit motion may also be accomplished using a sequence of actuations. A stepper motor is a classic example of this, whereby directional movement is produced by the sequential activation of different coils in the motor. FIGS. 3A-B depict a discrete motion system that employs a similar strategy, but uses mechanical latches rather than electromagnetic ones. The system can move itself along a discrete grid by actuating one of four solenoids at a time and shifting the machine by ¼ of a grid-pitch per actuation. Seen in FIG. 3A are exemplary lattice 302, with four solenoids 305, 310, 315, 320, four triangular-shaped end-effectors (pistons) 330, 335, 340, 345, and rails 350.

FIG. 3B is a bottom view of lattice 302 over a full sequence 360, 365, 370, 375 of activations, in which the four solenoids 305, 310, 315, 320 are actuated in sequence in order to propel the discrete motion module along lattice 302. As each solenoid 305, 310, 315, 320 is actuated, a corresponding triangular-shaped piston 330,335, 340, 345 is forced between two lattice parts. Rails 350 constrain the motion to be axial along the length of the motion module, and the module is moved by ¼ of the lattice pitch for each solenoid activation. This then positions the next triangular piston into a position to move the module by another ¼ of the lattice pitch. In activation sequence 360, piston 330 is currently active, having been forced between the lattice parts, and piston 335 is positioned to move the module next. In activation sequence 365, piston 330 has returned to the inactive position, piston 335 is active, and piston 340 is positioned to move the module. In activation sequence 370, piston 335 has returned to the inactive position, piston 340 is active, and piston 345 is positioned to move the module. Finally, in activation sequence 375, piston 340 has returned to the inactive position, and piston 345 is active.

Another preferred embodiment is illustrated in FIG. 4. Both of the systems of FIGS. 3A-B and FIG. 4 are capable of bidirectional (forward and backward) motion depending on the sequence of actuator activations. The embodiment of FIG. 4 uses an inchworm-type discrete movement sequence of actuations. In this embodiment, three actuators are used to extend/contract the body of the machine and latch/release each end.

FIG. 4 depicts the sequence 405, 410, 415, 420, 425 of activations required to move module 440 across lattice surface 445. Depicted in FIG. 4 are top views of lattice surface 445 and inchworm-type discrete motion module 440, having top segment 450 and bottom segment 455, with flexural locking arms 460, 465 and flexural expanding/contracting body joint 470. Module 440 has three degrees of freedom due to the two locking arms 460. Each joint is activated with a single degree of freedom actuator (such as, but not limited to, a solenoid). As upper locking arm 460 is activated 405, triangular end-effector 480 is forced between two lattice parts, thus constraining its position. Body joint 470 is then actuated 410 to move lower segment 455 up by one lattice pitch. Lower locking arm 465 is then actuated 415 to lock module 440 in place again by means of triangular end-effector 485. Upper locking arm 460 can now be disengaged 420 and body joint 470 extended 425 by one lattice pitch. This process is then repeated to move the module along the lattice surface.

It is generally desirable for a system to have as few degrees-of-freedom as necessary, especially in the case of modules that may be assembled into larger systems. For this reason, mechanisms to reduce the number of actuated degrees-of-freedom were developed.

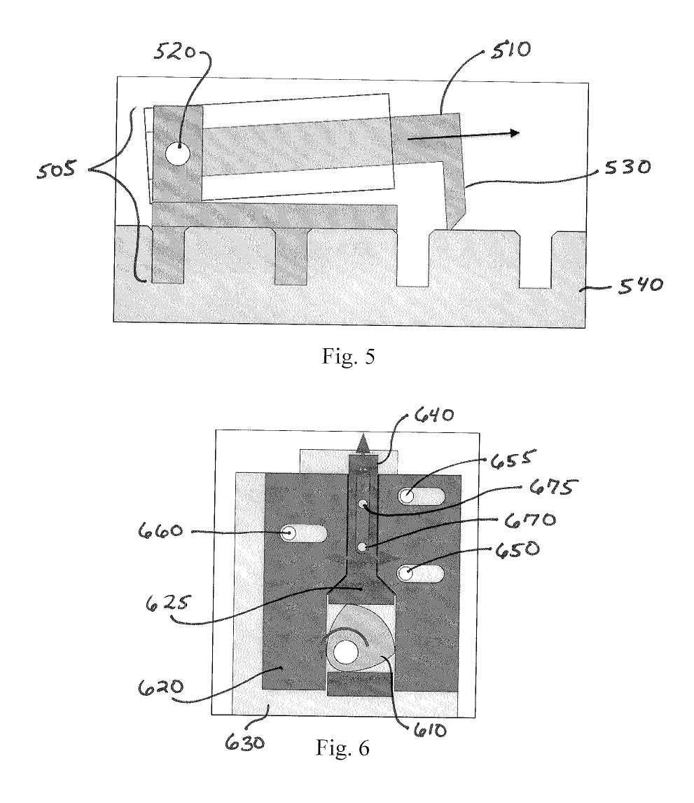

A ratchet mechanism, for example, enables an inchworm-type motion module to have a single degree of freedom to move in or out. By adding a chamfer on the arm end-effector and a passive hinge joint, the single degree of freedom enables a complex motion that either pushes or pulls the inchworm across the lattice. FIG. 5 is an illustration of a digital inchworm-type discrete motion module 505 with a ratchet-type mechanism that reduces the required number of degrees of freedom. In FIG. 5, the only actuated joint of module 505 is piston arm 510, which can move in and out. Passive (non-actuated) pivot hinge 520 (preloaded downward by gravity) allows ratcheting chamfer 530 to ride up a slot of lattice 540 while piston 510 is extending, but then slide over and lock downward to pull module 505 forward to the next lattice slot while it is contracting.

A cam system can be used to create more complex trajectories while reducing the number of degrees of freedom in a discrete movement. FIG. 6 depicts an exemplary cam mechanism to produce a square end-effector trajectory from rotary motion. In this case, a cam (derived from a curve-of-constant-width) produces a side-to-side and up-and-down motion of two linear sliders, resulting in a square trajectory of the end effector. This end effector can then be used to move on a lattice by one pitch per revolution of the cam. In FIG. 6, as cam 610 of constant width is spun between two sliders 620, 625, one in the x-direction 620 and one in the y-direction 625, within stationary structure 630, it moves end effector 640 in a square trajectory, first moving up (vertically up), then over (horizontally), then down (vertically down) and then back (horizontally). Sliders 620, 625 are constrained by three pins 650, 655, 660 in the x-direction and two 670, 675 in the y-direction.

Motion Systems for Digital Manufacturing. These discrete (digital) motion machines can be coupled together and used to assemble more complex motion systems; furthermore, the motion systems can exist in many different topologies and can even change size and shape dynamically. This is enabled by giving the digital motion machines the ability to assemble the lattice on which they move.

Assembly of arbitrarily-sized structures is possible with the digital assembly technique of the invention by allowing the assembler machine to traverse and precisely position itself on the lattice. In this arrangement, the lattice acts as the geared motion system of a traditional gantry, where the assembler uses the lattice as both positioning guide rails and gearing onto which to transmit power for locomotion. The assembler is then able to place lattice components that contribute to the overall lattice structure, unconstrained by traditional predetermined gantry size limits.

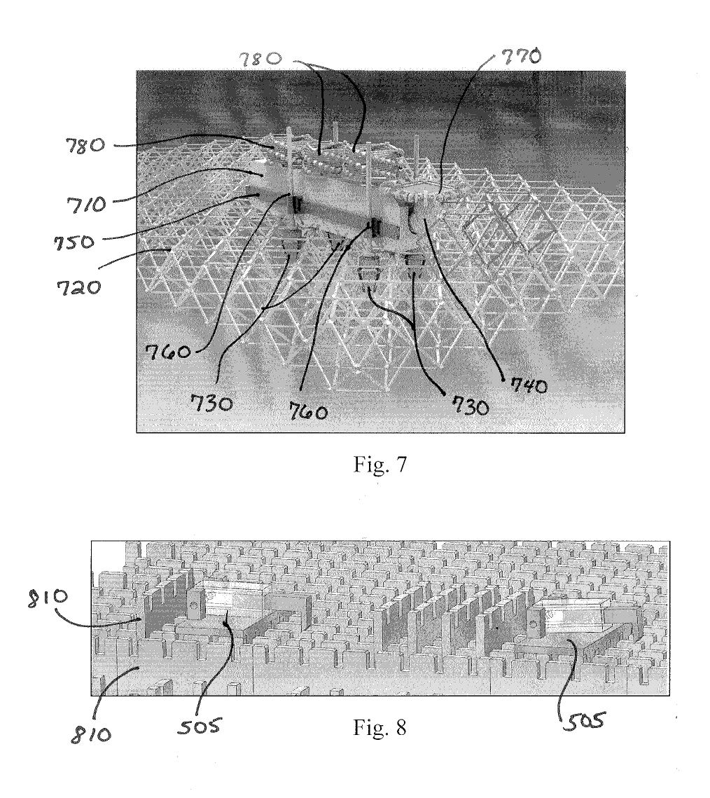

FIG. 7 depicts a cube-oct lattice assembler robot that employs many of the modules discussed previously, such as lattice-positioning feet that “snap” into the lattice. Parts are stored on the robot, and it uses its arm to place the parts. Shown in FIG. 7 are discrete assembly robot 710, sitting on cube-oct lattice 720, and having kinematically-locating feet 730 (such as in FIG. 1), part placing arm 740, linear rail 750, and dual prismatic joints 760. Active part 770 and stacks 780 of discrete parts are waiting to be placed by part-placing arm 740.

FIG. 8 depicts an embodiment of a discrete assembler, having inchworms 505 of the type shown in FIG. 5, depositing digital material parts as they crawl across lattice 810, placing parts that are able to be vertically assembled.

These structures may not only be assembled, but also actuated by the one-bit assemblers. The mobile assembly machines, which, in assembly mode, take discretized steps across a lattice, may transition to actuation mode by fixturing themselves to the structure and performing work by making discretized steps on a secondary lattice structure that is constrained and actuated by these discrete motion machines. In this arrangement, the discrete motion machines transform a static structure into a machine with controlled moving components. The secondary lattice structure may be referred to as a moving axis and, as such, a traditional gantry system with linear degrees of freedom.

In an alternative system topology, rather than the assembler moving on the lattice, the lattice is moved by a static assembler machine. This is a more traditional assembly arrangement, where there is a static assembler head and a gantry moves the lattice such that new pieces may be assembled in the desired position. Motion of the lattice may again be made with discretized steps on a one-bit motion system. Parts are stored and deposited by the assembler head while the growing lattice is moved by mechanisms below the surface of the assembly platform (these mechanisms might be those shown in FIG. 6, for example).

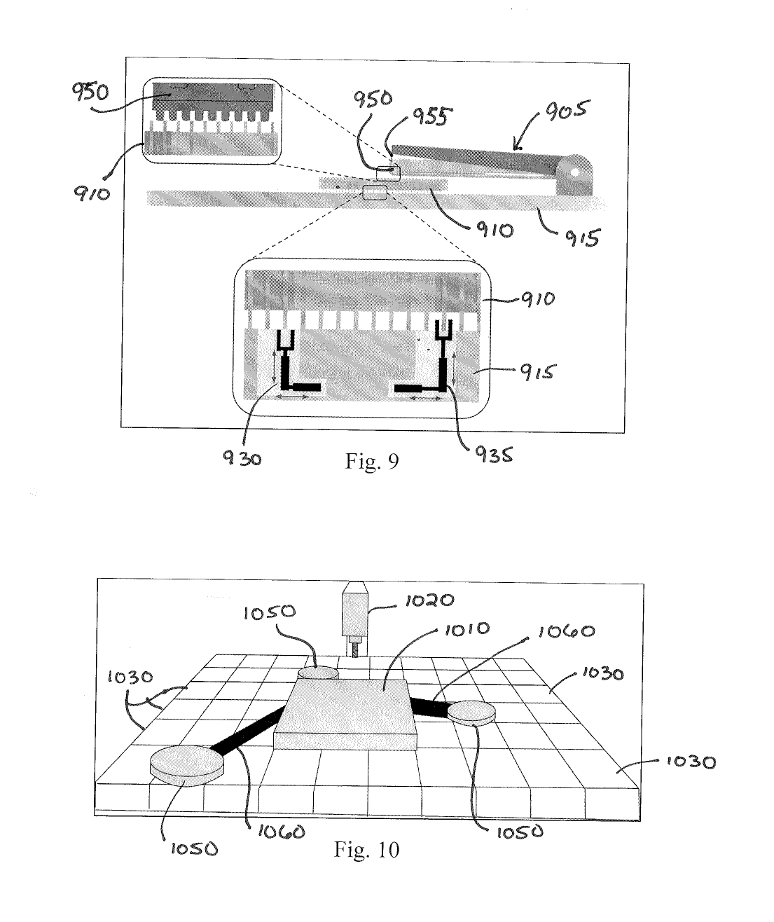

FIG. 9 depicts an exemplary discrete motion system for a digital assembler resembling a stapler. In FIG. 9, stapler-style assembler 905 discretely positions lattice 910 on stationary structure 915 using a cammed discrete motion system such as the one shown in FIG. 6. Two square-trajectory end-effector discrete motion modules 930, 935 are used to move lattice 910 in the x-direction and another two are used to move lattice 910 in the y-direction. Stapler-style assembler 905 aligns itself with lattice 910 using chamfered alignment features 950 (front view) at the head 955 of the stapler 905. These interlock with the lattice parts to precisely position it.

Coupled together, these digital motion machines are also capable of making continuous motions. This opens up the possibility of outfitting the system with an analog head rather than an assembly head. This analog head may be, for example, but not limited to, a milling spindle, a fused deposition modeling extruder, or a knife blade.

FIGS. 10-12 depict digital motion systems wherein the head moves along a number of arms that can move parallel to the lattice grid structure. Each arm can rotate parallel to the grid, can extend, and can attach and detach itself from the grid tiles. This allows full range of motion between grid tiles, and continuous motion can be achieved at the speeds at which the arms can be extended. The head can handle attaching itself and re-attaching itself to different parts of the grid structure, as well as maintaining continuous motion parallel to the grid structure in support of a machining head.

FIG. 10 depicts a setup with digital motion stage 1010 under spindle 1020. Each tile 1030 is added individually to the lattice, and the digital inchworm can walk on it regardless of size, using feet 1050 attached by prismatic joints 1060 that can extend and contract. Here stage 1010 could be much larger to occupy more of the machine's footprint, but for the purposes of this illustration a smaller stage is depicted. The inverse set up is also possible, with the spindle being on the digital inchworm and the stage being fixed.

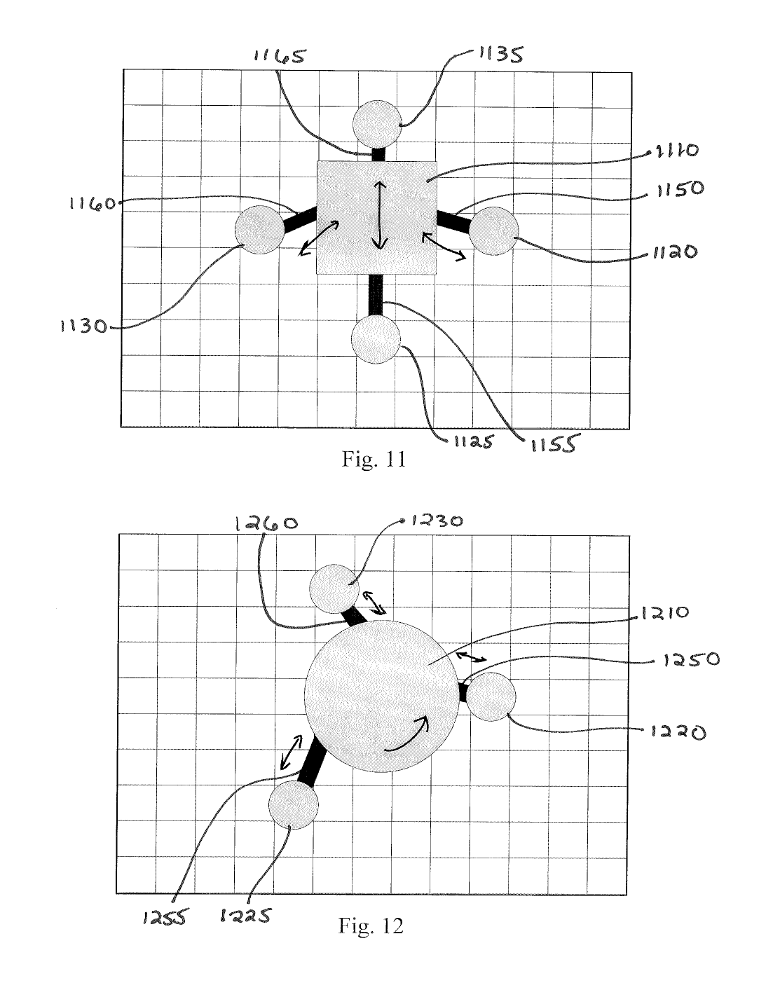

The discrete motion system can have a variable number of moving members attached to its head. FIG. 11 depicts an exemplary digital motion system where the head moves along 4 arms that can move parallel to the grid structure. Shown in FIG. 11 are digital motion stage 1110 with a digital head having four feet 1120, 1125, 1130, 1135 attached by corresponding prismatic links 1150, 1155, 1160, 1165. To keep motion on a single layer, the power transmission for two axes may be designed to take advantage of complementary drive shafts in each axis. In the system of FIG. 11, feet 1120, 1125, 1130, 1135 are fixed to the grid, and the head is able to move in the middle. Because there is range of motion for the head and there are redundant attachment points, some of the attachment points can disconnect and reconnect to allow continuous motion along the grid.

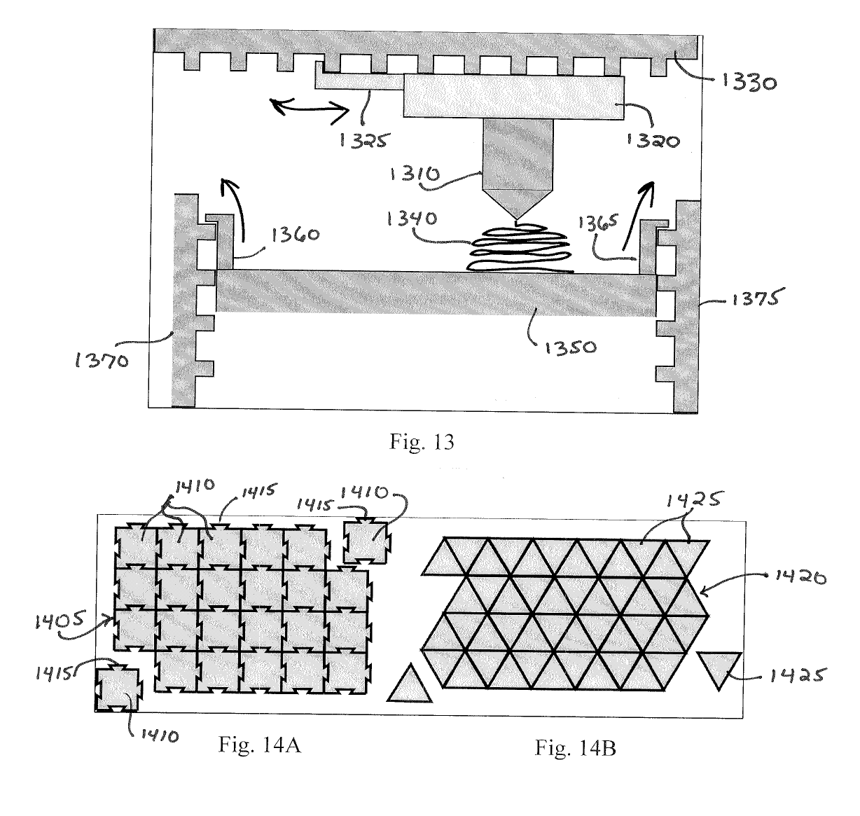

FIG. 12 depicts an exemplary digital motion system wherein the head moves along 3 arms that can move parallel to the grid structure. In FIG. 12, a digital inchworm with 3 legs is attached to a square grid. Shown in FIG. 12 are digital motion stage 1210 and three feet 1220, 1225, 1230 attached to corresponding prismatic links 1250, 1255, 1260. Different numbers of members will require different control algorithms, but all will effectively result in motion in the x-y plane. Similarly, different grid geometries may result in different placement methods and control algorithms, but will result in the same motion.

In order to be able to move a larger structure along parallel tile walls, the redundant digital motion system arms can operate symmetrically, moving the whole system at once. FIG. 13 depicts a 3d print head extruder 1310 mounted on xy inchworm 1320, having chamfer arm 1325 that attaches to lattice 1330. The object being built 1340 rests on stage 1350 attached to z inchworms 1360, 1365, which are attached to lattice 1370, 1375, respectively. This setup allows for full 3-axis control, and thus the printing of parts in a flexible volume size.

The lattice pieces (tiles) that the discrete motion system moves on can have many different geometries and need to be accurate and repositionable in order to ensure a precise foundation for the discrete motion module to move on. To ensure this, the lattice pieces should be connected to each other with rigid couplings. In effect, the lattice pieces represent a digital material, such as the type described G. Popescu, “Digital Materials for Digital Fabrication”, Master's thesis, Massachusetts Institute of Technology, Cambridge, Mass., 2007. Some of the options suitable for rigid, error correcting digital material include, but are not limited to, snap fit connectors, preloaded slide connections, or even magnetic connectors.

FIGS. 14A-B depict exemplary lattice geometries usable with the present invention. FIG. 14A depicts lattice 1405 having interlocking lattice tiles 1410 with jigsaw-type interlocking joints 1415 and FIG. 14B depicts exemplary lattice structure 1420 comprising triangular lattice pieces 1425.

Many means for connecting the lattice tiles are known in the art, and include, but are not limited to, snap-fit connections, magnetic connectors with kinematic couplings, hinged fasteners, or other systems. Suitable means include, but are not limited to, those shown in Bonenberger, Paul R., “The First Snap-Fit Handbook: Creating and Managing Attachments for Plastic Parts”, Hanser Verlag, Aug. 30, 2005. For example, suitable means may include a loop-style cantilever lock, in which reaction force against separation is along the neutral axis of the beam so that the bean is in tension, not bending. A ratchet closure to keep the structure rigid can be added, or spring-loaded connections, or live hinges in the connection points.

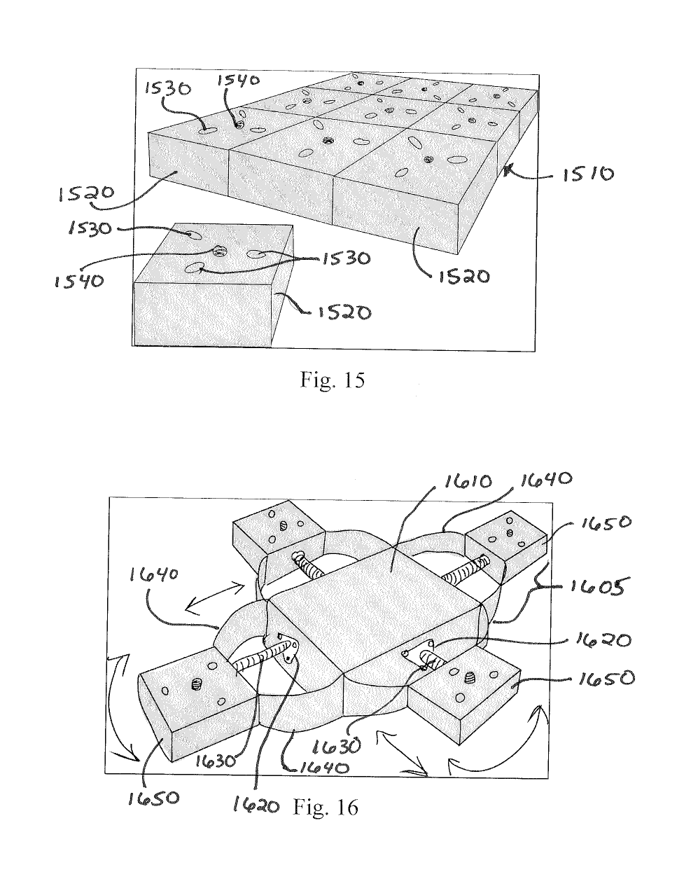

The attachment system that the digital motion system uses to connect to the lattice grid should also preferably be rigid, repeatable, and accurate. FIGS. 15 and 16 are examples depicting how a kinematic coupling may be used to attach the various arms of a motion system to the grid.

As shown in FIG. 15, kinematic lattice structure 1510 is comprised of tiles 1520, each having one or more kinematically locating slots 1530 and a threaded hole 1540 that allows a bolt to apply a preload. This example of a tile system permits the head of the digital inchworm to attach to the tiles with a kinematic coupling. Tiles 1520 can be attached to each other using snap-fit connections, magnetic connectors with kinematic couplings, hinged fasteners, or other systems known in the art.

FIG. 16 is a ‘belly up’ depiction of an exemplary embodiment of a digital inchworm that can attach to a kinematic lattice structure such as the exemplary one depicted in FIG. 15. As shown in FIG. 16, stage 1610 has four “legs” 1615, each comprising a lead screw nut 1620, lead screw 1630, two linear flexure bearings 1640, and kinematic coupling modules (“feet”) 1650. Each leg 1615 has 3 degrees of freedom, one allowing it to pivot, one allowing it extend, and one that represents a motorized screw for attaching to the mounts in the tiling system. An actuator in the end-effector can screw into a hole in the tile structure, binding 3 spheres into 3 grooves and thereby disabling any motion of that foot.

System control. Control of the system and individual modules can be achieved through any of the many methodologies and apparatus known in the art. This can include remote control, via wireless links, wired links, or through the lattice, and on-board control, via programmable microprocessors (preprogrammed or wirelessly programmed) or other similar means. Power can be supplied remotely (for example, via the lattice or wirelessly) or may be carried on-board individual modules, in the form of batteries, solar cells, or any of the other means know in the art for independently powering electronic devices.

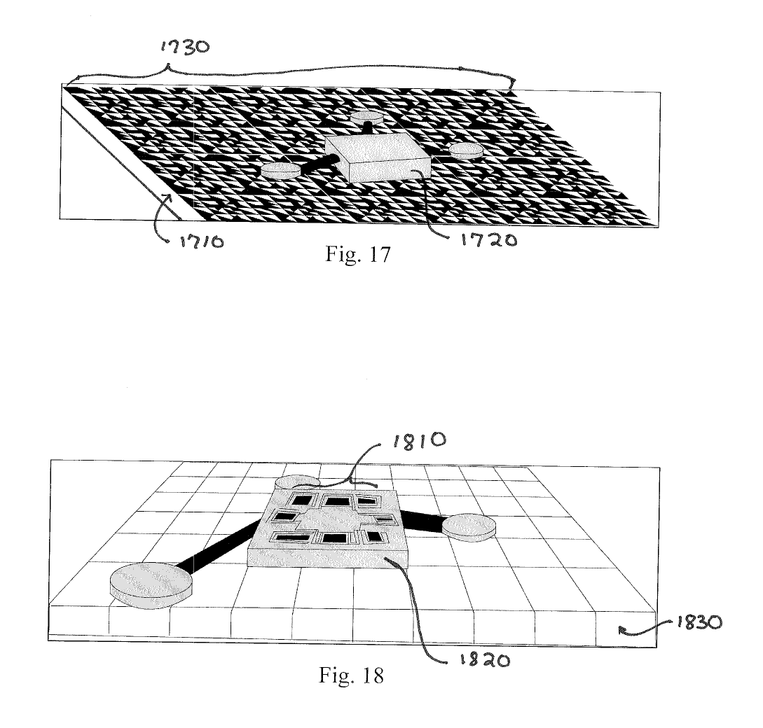

In one embodiment, depicted in FIG. 17, in order to achieve greater accuracy in the digital motion systems, the system is extended to include closed loop control. This is achieved by including an optical pattern on each of the tiles, and using a sensor on the digital inchworm head to read out the pattern. If the system misses steps in motion, it can be corrected using a feedback loop with the optical sensors. In the exemplary embodiment of FIG. 17, the tile structure 1710 (lattice) that motion module 1720 (e.g. a digital inchworm head such as in FIGS. 10-12) climbs on is covered in unique optical encoding 1730. The head in this embodiment can read out the encoding as it passes by and use it for closed loop control.

To achieve finer resolution motion with the digital motion system, a layer of motion control may also be added in the form of a flexural stage on top of the closed loop digital inchworm platform itself. While the platform maintains position using the linear actuators and optical sensors in the head, the flexural stage on top of the head can maintain its relative position using its own actuators and encoders.

This kind of layering of control systems is enabled by the modular design of the motion system. In the exemplary embodiment of FIG. 18, a kinematic xy flexure mechanism 1810 (flexural closed loop motion stage) is placed as described in S. Awtar, “Synthesis and Analysis of Parallel Kinematic XY Flexure Mechanisms”, PhD thesis, 2004, on top of digital inchworm stage 1820, which is on top of the discrete grid of passive lattice tiles 1830, in order to enable higher resolution positioning of active head. Because such flexure mechanisms move with nanometer resolution, the resolution of the overall system can be greatly increased, assuming that feedback from the sensors of the digital inchworm and of the flexure mechanism can be used to position the flexure. Using several control layers, it is possible to achieve both extended range and high resolution for this motion system.

These motion modules and assemblers may be controlled by any of the many means for machine control known in the art of the invention. The discrete assemblers, for example, may be controlled wirelessly by a stationary base station. In such an embodiment, the base station does “toolpathing” to determine where each assembler should move and then sends the relative motions to each robot.

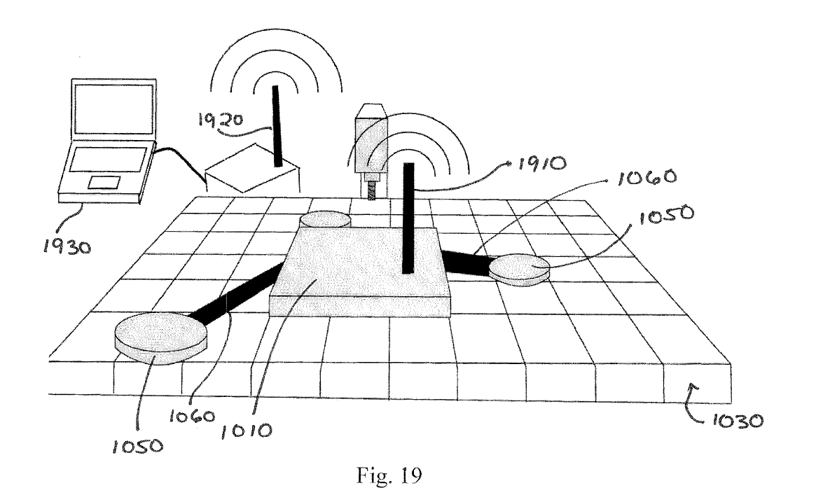

FIG. 19 depicts the setup of FIG. 10, adapted to provide wireless remote control of the assembler. In FIG. 19, digital motion stage 1010 under spindle 1020 is provided with wireless transceiver 1910 for communication with base station 1920. The digital inchworm can walk on lattice 1030 using feet 1050 attached by prismatic joints 1060 that can extend and contract. Stage 1010 receives control commands wirelessly from base station 1920 which relays commands and coordinates to the stage from computer 1930.

This kind of control and communication can also be implemented without relying on wireless links. For example, both power and logic signals may be sent through the lattice itself; that is to say, by using conductive lattice pieces (or lattice parts with conductive traces), electrical networks for power and signal routing can be used to power and communicate with the individual assemblers. The assembler is always connected to at least one point on the lattice such that it can receive power and instructions through “the grid.” These kind of discretely assembled electrical networks are described in Ward, J., “Additive assembly of digital materials,” Master's thesis, Massachusetts Institute of Technology, 2010.

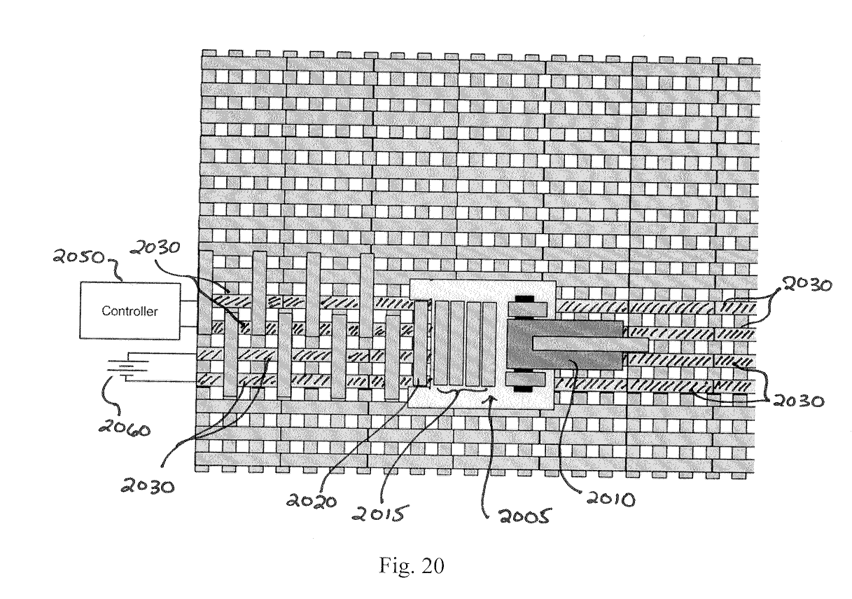

FIG. 20 depicts an exemplary discrete motion relative assembler 2005, having inchworm ratchet mechanism 2010 of the type 505 depicted in FIG. 5, placing parts from part stack 2015, with part 2020 being the part next to be placed. Discrete motion relative assembler 2005 is controlled and powered through lattice 2025, with conductive lattice pieces 2030 (hatched) relaying electrical signals from control base station 2060 and power source 2070, which are connected to the edge of lattice 2025.

In an alternate embodiment, processing is distributed amongst the collective whole. Each assembler can communicate with local neighbors to update their model of the structure as a whole. This kind of networking has been described and implemented for paintable computing in A. Knaian, I). Greenspan, W. Butera, J. Jacobson, N. Gershenfeld, “Technology Evaluation for Paintable Computing and Paintable Displays: RF Nixel Seedling,” June 2004 to September 2005, Final Report, April 2006.

Control algorithms for active moving machine heads such as digital inchworms are known in the art. Suitable examples may be found in, but are not limited to those described in, Lebret, G. et al., “Dynamic Analysis and Control of a Stewart Platform Manipulator”, Journal of Robotic Systems, Vol. 10, No. 5, pp. 629-655, July 1993, which is herein incorporated by reference in its entirety.

In a preferred embodiment, i order to control the movement of a discrete motion module, a transformation that takes the speed of the end-effector and translates it to the speeds that the individual possibly interdependent joints will need to move is used. This transform is typically described using a Jacobian matrix, where the vector θ represents the joint angles, and s represents the positions of the end-effectors. The Jacobian matrix is given by:

$$J ( θ ) = [ \begin{matrix}\frac{\partial {s}_{1}}{\partial {θ}_{1}} & ⋮ & \frac{\partial {s}_{i}}{\partial {θ}_{1}} \\ ⋮ & ⋱ & ⋮ \\ \frac{\partial {s}_{1}}{\partial {θ}_{j}} & … & \frac{\partial {s}_{i}}{\partial {θ}_{j}}\end{matrix} ]$$

Taking the inverted (or pseudo-inverted) matrix J and the desired end-effector position, the individual joint speeds can be calculated. This practice is common in the art of the invention and will be understood by one of ordinary skill in that art.

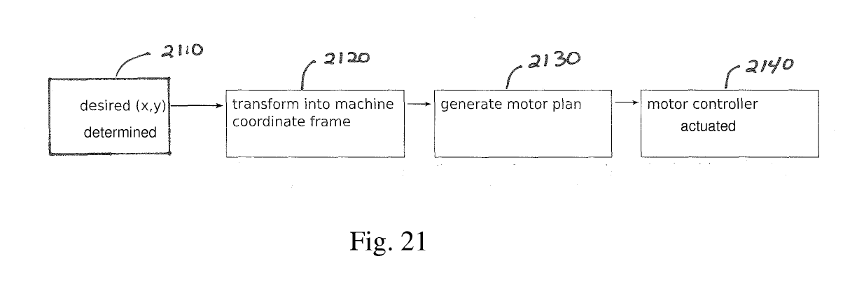

FIG. 21 is a flowchart of an exemplary general control algorithm for a discrete relative motion system according to the invention. In FIG. 21, the desired end-effector position is determined 2110, then transformed 2120 into a machine coordinate frame using a kinematic Jacobean matrix to calculate the transform. The motor plan is generated 2130 by computing the Δ between the current and desired position, and then the motor controller is actuated 2140 to move the end-effector.

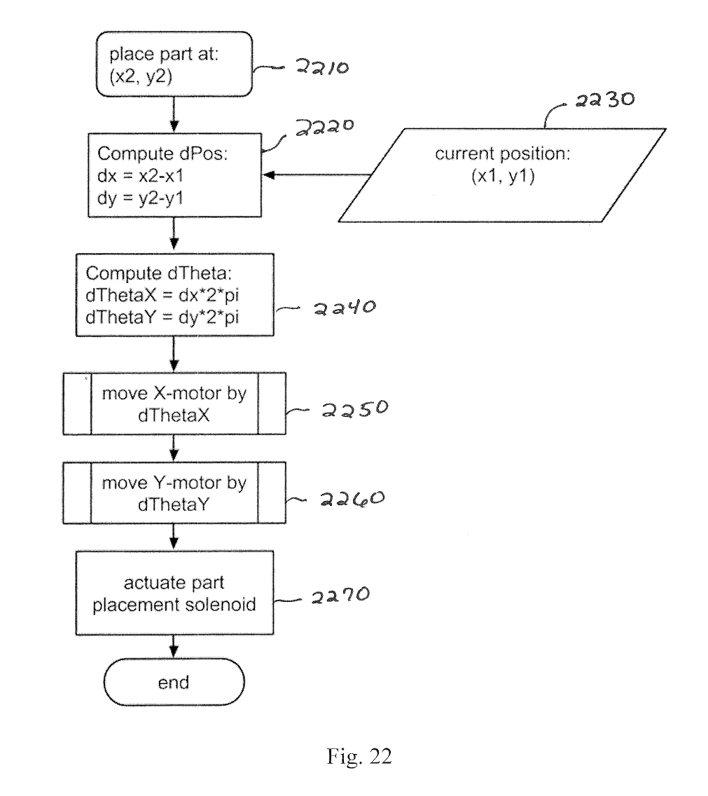

FIG. 22 is a flowchart of an exemplary control algorithm specifically designed for the stapler-style discrete relative motion system of FIG. 9. In FIG. 22, the part is placed 2210 at an initial position, the required x- and y-changes in position are calculated 2220 from the part position and current position 2230, and the required amount of x- and y-motor movements are calculated 2240 from the required x- and y-changes in position. The X-motor and Y-motors are moved 2250, 2260 according to the computed amounts, and then the part placement solenoid is actuated 2270.

The use of discrete motion systems according to the invention ensures that positioning errors are corrected as they happen. In this way, the task of accurate positioning is outsourced to the lattice rather than being the job of the robot that assembles it. The combination of digital assembly machines, multiple lattice structures, and analog heads provides the ability to build arbitrarily sized and reconfigurable gantry-based fabrication tools. This can be used to replace any precision stage that requires reconfiguration, such as biology lab equipment, on-site machining applications, and small-batch automation. A preferred embodiment discrete extensible motion system is applied to digital fabrication problems, including both an application using traditional analog materials and one using reconfigurable digital materials.

While preferred embodiments of the invention are disclosed herein, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims.

What is claimed is:

1. A discrete motion system, comprising:
a lattice, the lattice having a regular configuration of attachment points;
at least one discrete motion module, wherein each discrete motion module is controllable to move across the lattice in discrete increments defined by the regular configuration of attachment points, each discrete motion module comprising:
at least one actuator configured to cause movement of the motion module across the lattice;
a module body connected to the at least one actuator; and
at least one attachment foot member attached to the module body, each foot member being responsive to actuation of at least one of the at least one actuator and comprising at least one attachment mechanism that is controllable to alternately attach the motion module to the lattice at one or more of the regular attachment points and release the module from the lattice as the module moves across the lattice; and
at least one controller configured for causing actuation of the at least one actuator in order to cause the movement of the discrete motion module across the lattice.

2. The discrete motion system of claim 1, wherein each foot member is attached to the module body by at least one arm structure.

3. The discrete motion system of claim 2, further comprising at least one actuated joint, the at least one actuated joint being responsive to the at least one actuator and causing movement of the arm structure to cause engagement and disengagement of the foot member from the lattice.

4. The discrete motion system of claim 1, wherein the discrete motion module is a digital inchworm.

5. The discrete motion system of claim 4, wherein the digital inchworm comprises a piston arm actuated joint attached to the module body by a pivot hinge, the piston arm being configured to extend and contract under control of the actuator, and the foot comprises a ratcheting chamfer that rides up the lattice while the piston arm is extending, and slides over and locks downward to pull the motion module forward along the lattice while the piston arm is contracting.

6. The discrete motion system of claim 1, wherein the discrete motion module and controller further comprise at least one wireless link and the at least one controller communicates wirelessly with the motion module to initiate actuation of the at least one actuator.

7. The discrete motion system of claim 1, wherein the controller is on-board the discrete motion module.

8. The discrete motion system of claim 1, wherein the discrete motion module employs a bistable mechanism to move between attachment points on the lattice.

9. The discrete motion system of claim 1, wherein the at least one attachment mechanism is an end-effector that fits into the regular attachment points on the lattice.

10. The discrete motion system of claim 1, wherein the discrete movement module further comprises an onboard power source.

11. The discrete motion system of claim 1, wherein the lattice further comprises conductive pieces for providing at least one of power and control signals to the at least one discrete motion module.

12. The discrete motion system of claim 1, wherein the discrete motion module is a discrete motion relative assembler that further comprises at least one assembler arm.

13. The discrete motion system of claim 12, wherein the controller is configured to direct the discrete motion module to make additions to the lattice using the assembler arm.

14. A discrete motion relative assembler, comprising:
a discrete motion module, wherein the discrete motion module is controllable to move across a lattice in discrete increments defined by a regular configuration of attachment points on the lattice, the discrete motion module comprising:
at least one actuator configured to cause movement of the motion module across the lattice;
a module body connected to the at least one actuator;
at least one attachment foot member attached to the module body, each foot member being responsive to actuation of at least one of the at least one actuator and comprising at least one attachment mechanism that is controllable to alternately attach the motion module to the lattice at one or more of the regular attachment points and release the module from the lattice as the module moves across the lattice; and
at least one assembler arm attached to the module body, the assembler arm being configured for placing materials; and
at least one controller configured for causing actuation of the at least one actuator in order to cause the movement of the discrete motion module across the lattice and for directing placement of the materials by the assembler arm.

15. The discrete motion relative assembler of claim 14, wherein each foot member is attached to the module body by at least one arm structure.

16. The discrete motion relative assembler of claim 15, further comprising at least one actuated joint, the at least one actuated joint being responsive to the at least one actuator and causing movement of the arm structure to cause engagement and disengagement of the foot member from the lattice.

17. The discrete motion relative assembler of claim 14, wherein the discrete motion module is a digital inchworm.

18. The discrete motion relative assembler of claim 17, wherein the digital inchworm comprises a piston arm actuated joint attached to the module body by a pivot hinge, the piston arm being configured to extend and contract under control of the actuator, and the foot comprises a ratcheting chamfer that rides up the lattice while the piston arm is extending, and slides over and locks downward to pull the motion module forward along the lattice while the piston arm is contracting.

19. A method for discrete extensible construction, comprising the steps of:
creating a lattice having a regular configuration of attachment points;
causing a discrete motion relative assembler to systematically move across the lattice in discrete increments defined by the regular configuration of attachment points on the lattice, the discrete motion relative assembler comprising:
at least one actuator configured to cause movement of the motion module across the lattice;
a module body connected to the at least one actuator;
at least one attachment foot member attached to the module body, each foot member being responsive to actuation of at least one of the at least one actuator and comprising at least one attachment mechanism that is controllable to alternately attach the motion module to the lattice at one or more of the regular attachment points and release the module from the lattice as the module moves across the lattice; and
at least one assembler arm attached to the module body, the assembler arm being configured and controllable for placing materials; and
causing placement of materials by the assembler arm.

20. The method for discrete extensible construction of claim 19, wherein the materials placed by the assembler arm are lattice pieces and further comprising the step of directing the assembler arm to make additions to the lattice.
